(19) United States
(12) Patent Application Publication
(10) Pub. No.: US 2012/0144945 A1
(43) Pub. Date: Jun. 14, 2012

(54) SINGLE-PISTON THREE-POSITION HYDRAULIC ACTUATOR

(75) Inventors: Shushan Bai, Ann Arbor, MI (US); Vijay A. Neelakantan, Rochester Hills, MI (US); Paul G. Otanez, Troy, MI (US); Bret M. Olson, White Lake, MI (US)

(73) Assignee: GM GLOBAL TECHNOLOGY OPERATIONS LLC, Detroit, MI (US)

(21) Appl. No.: 12/966,349

(22) Filed: Dec. 13, 2010

(51) Int. Cl. F16D 25/06; F15B 15/20; F15B 15/14

(52) U.S. Cl. 74/473.11; 91/392; 92/130 R

(57) ABSTRACT

An actuator assembly includes a housing, a piston disposed within a portion of the housing. The piston has a movable range along a working-axis, and separates a first volume and a second volume within the housing. The assembly also includes a biasing feature disposed within the second volume, where the piston is configured to engage the biasing feature within a first portion of the movable range, and configured to not engage the biasing feature within a second portion of the movable range.

### TECHNICAL FIELD

The present invention relates generally to single-piston, three-position hydraulic actuators.

### BACKGROUND

Actuators are typically used to mechanically engage or disengage one working part from another. One class of actuators includes a three-position actuator that may be capable of achieving two extreme movement positions, along with an intermediate position between the two extremes. In such actuators, hydraulic fluid control is known to be capable of high-force applications, along with the ability for a relatively long actuator travel range.

### SUMMARY

A three-position actuator assembly includes a housing, and a piston disposed within a portion of the housing and having a movable range aligned with a working-axis. The piston may separate a first volume and a second volume within the housing, and the assembly may further include a biasing feature disposed within the second volume. The piston may be configured to engage the biasing feature within a first portion of the movable range, and configured to not engage the biasing feature within a second portion of the movable range. In an embodiment, the biasing feature may include a spring and/or contact ring. The spring may, for example, be configured to apply a force between the contact ring and a portion of the housing, where the piston may interface with a portion of the contact ring.

In an embodiment, the biasing feature may be configured to apply a pre-loaded force to a land or feature of the housing when the piston is not in contact with the biasing feature. The land may be, for example, a shoulder or ridge that may exist between two cavities of the housing, each having a differing cross-sectional profile.

In an embodiment, a pressure difference between the first and second volumes may impart a net hydraulic force to the piston. A net hydraulic force in a first range may cause the piston to assume a first position along the working-axis, a net hydraulic force in a second range may cause the piston to assume a second position along the working-axis, and a net hydraulic force in a third range may cause the piston to assume a third position along the working-axis. Within each of the first, second and third net hydraulic force ranges, the piston may be positionally stable.

In an embodiment, one of the positions along the working-axis is within the second portion of the movable range. Additionally, in an embodiment, the pressure gradient may be controlled by controllably allowing fluid to pass through one or more apertures provided in the housing.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1A is a schematic cross-sectional view of an embodiment of a hydraulic actuator in a first position.

FIG. 1B is a schematic cross-sectional view of the hydraulic actuator of FIG. 1A shown in a second, intermediate position.

FIG. 1C is a schematic cross-sectional view of the hydraulic actuator of FIG. 1A in a third position.

FIG. 2 is a graph of actuator location as a function of a pressure gradient across a hydraulic piston for an embodiment of a hydraulic actuator.

FIG. 3 is a table of inlet pressures that may achieve various actuator states for an embodiment of a hydraulic actuator.

FIG. 4A is a schematic cross-sectional view of an embodiment of a hydraulic actuator in a first position.

FIG. 4B is a schematic cross-sectional view of the hydraulic actuator of FIG. 2A in a second, intermediate position.

FIG. 4C is a schematic cross-sectional view of the hydraulic actuator of FIG. 2A in a third position.

FIG. 5 is a graph of actuator location as a function of a pressure gradient across a hydraulic piston for an embodiment of a hydraulic actuator.

FIG. 6 is a table of inlet pressures that may achieve various actuator states for an embodiment of a hydraulic actuator.

FIG. 7 is a schematic illustration of an embodiment of a hydraulic actuator for engaging a transmission synchronizer gear assembly.

### DETAILED DESCRIPTION

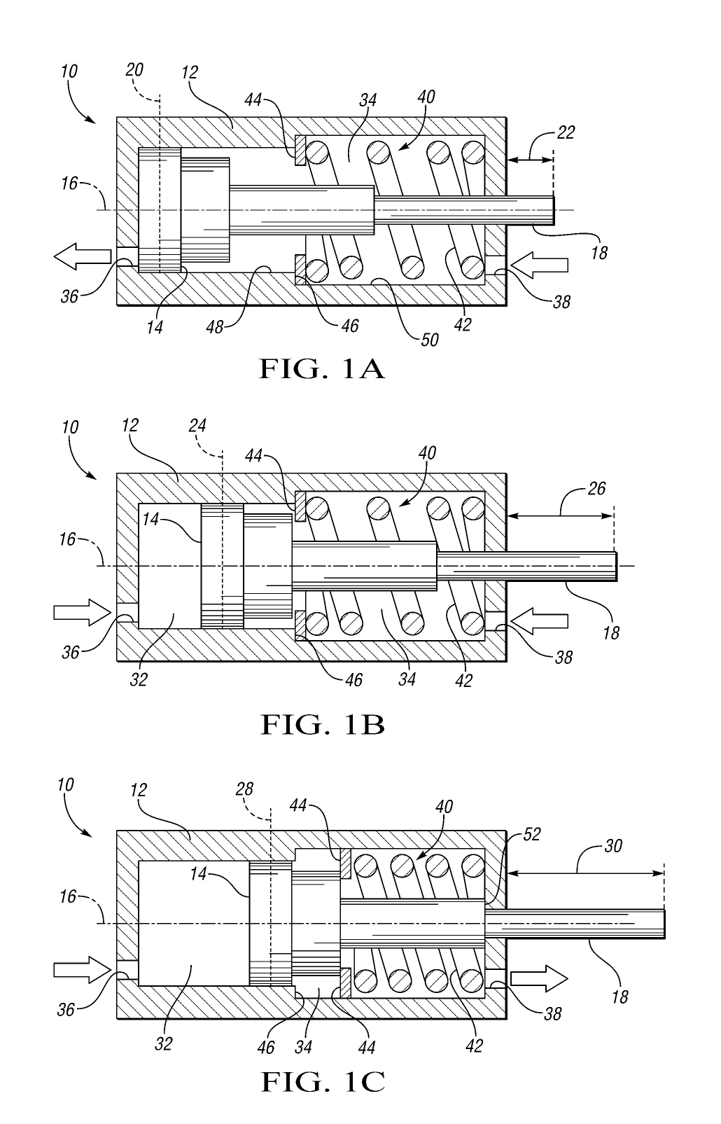

Referring to the drawings, wherein like reference numerals are used to identify like or identical components in the various views, FIGS. 1A-1C illustrate an embodiment of a hydraulic actuator assembly 10. The actuator assembly 10 may include a housing 12, and a piston 14 disposed within a portion of the housing 12. The piston 14 may be configured to linearly translate within the housing 12 along a working-axis 16, as demonstrated sequentially in FIGS. 1A-1C.

As further illustrated in FIGS. 1A-1C, the piston 14 may be coupled with an actuator rod 18 either directly, or through one or more intermediate components. The actuator rod 18 may extend through a portion of the housing 12 and may be configured to interface with one or more external systems. In an embodiment, the extension of the actuator rod 18 from the housing 12 may vary based on the position of the piston 14. For example, as shown in FIG. 1A, when the piston 14 assumes a first position 20 along the working-axis 16, the actuator rod 18 may extend a first distance 22 from the housing 12. Likewise, when the piston 14 moves to a second 24 or a third 28 position along the working-axis 16, as respectively shown by FIGS. 1B and 1C, the rod extension 26, 30 may similarly increase.

As illustrated in FIGS. 1B and 1C, the piston 14 may separate a first volume 32 from a second volume 34 within the housing 12. As illustrated in FIG. 1A, however, the first volume 32 may decrease toward zero as the piston 14 approaches contact with the housing 12. In an embodiment, each of the first and second volumes 32, 34 may include one or more apertures that are in fluid communication with the respective volume. For example, as shown, aperture 36 is in fluid communication with the first volume 32, and aperture 38 is in fluid communication with the second volume 34. The apertures may allow a hydraulic fluid to controllably pass into or out of the volume in a manner that may be used to manipulate the position of the piston 14 along the working-axis 16.

The actuator assembly 10 may further include a biasing feature 40 that may engage the piston 14 over a portion of the piston's total movable range. The biasing feature may include, for example, a spring 42 that is configured to apply a force to a portion of the piston when the piston is in a portion of the range where it may mechanically contact the spring.

In an embodiment, the biasing feature 42 may additionally include a contact ring 44 that is movable along the working-axis 16 and may provide a uniform surface to engage the piston 14. As illustrated in FIGS. 1A-1C, the spring 42 may be positioned between the movable contact ring 44 and a portion of the housing 12. In an embodiment, the contact ring may interface with a feature or land 46 of the housing 12 that may prevent the contact ring 44 from traveling along a portion of the working-axis 16. In an embodiment, the land 46 may include, for example a shoulder between two different sized cavities of the housing (e.g., cavities 48, 50). The spring 42 may be pre-loaded with a predetermined spring force that may press the contact ring 44 against the land 46 when the piston 14 is not in contact with the ring 44.

As illustrated in FIG. 1A, the piston may assume a first position 20 along the working-axis 16 when the piston 14 is not engaged with the biasing feature 40. Such a first position 20 may be achieved by exhausting the fluid from the first volume 32 through aperture 36 while pressurizing the second volume 34 via aperture 38. The pressure difference between the exhausted first volume 32 and the pressurized second volume 34 will impart a net force on the piston 14 that urges it to a retracted state with a minimal rod extension 22 (i.e., in a “negative” direction).

As illustrated in FIG. 1B, the piston may be brought to a second position 24 along the working-axis 16 by pressurizing the first volume 32 via the provided aperture 36, while maintaining a positive pressure in the second volume 34. In an embodiment, the differences in the fluidly-exposed cross-sectional areas provided on either side of the piston 14 may result in a “positive” net force being applied to the piston 14 if the pressure in each volume 32, 34 is equal. In an embodiment, the net forces on the piston may be balanced by the biasing feature 40 once the piston 14 contacts or engages the feature 40. In an embodiment, a pre-loaded force between the contact ring 44 and land 46 may cause the piston 14 to be positionally stable against the contact ring 44 for a range of net hydraulic forces.

Finally, as illustrated in FIG. 1C, the piston 14 may be brought to a third position 28 along the working-axis 16 by exhausting the second volume 34, while maintaining a positive pressure in the first volume 32. In an embodiment, pressure difference between the exhausted second volume 34 and the pressurized first volume 32 will impart a net force on the piston 14 that overcomes any pre-loaded force between the contact ring 44 and land 46, and may further cause the biasing feature 40 to yield. For example, as shown in FIG. 1C, the contact ring 44 may move away from land 46, while the spring 42 compresses. In an embodiment, a portion of the piston 14 or actuator rod 18 may contact the housing 12 to provide a hard stop at the end of the range of motion. For example, as shown, a wider portion 52 of the actuator rod 18 may contact the housing 12 prior to the spring 42 reaching its point of maximum compression.

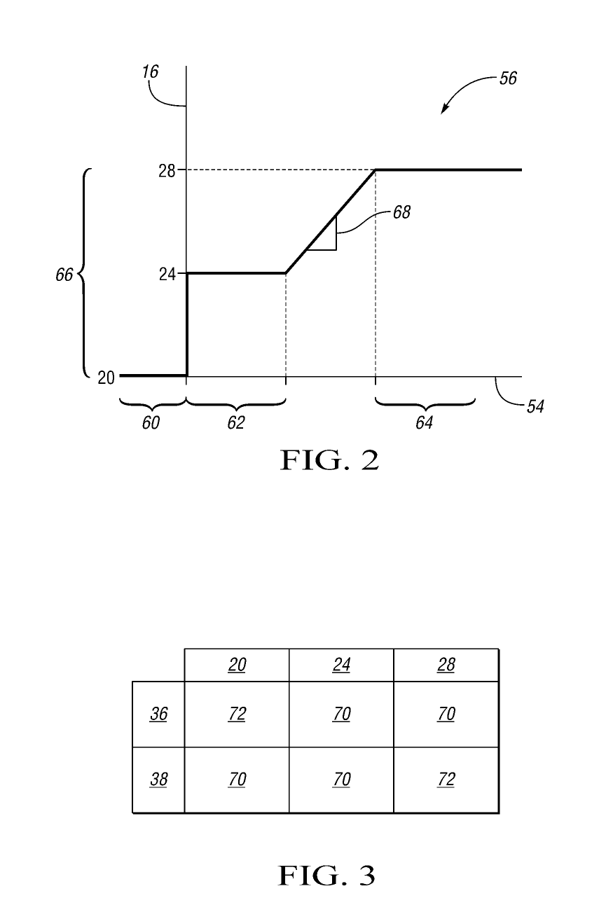

FIG. 2 is an exemplary graph 56 of a piston position along a working axis 16 of a hydraulic actuator assembly 10 as a function of a net hydraulic force 54 on the piston 14. The graph 56 illustrated in FIG. 2 may be representative of the operation of a hydraulic actuator assembly 10 such as the one shown in FIGS. 1A-1C. As illustrated, the piston position may be stable over three distinct force ranges 60, 62, and 64, with each range resulting in a different position along the working-axis 16 (i.e., positions 20, 24, and 28, respectively).

In the first force range 60, the piston 14 may experience a negative or zero net force, which may urge it toward a first position 20 at the extreme end of a working range 66. Upon crossing into a positive net force at the onset of range 62, the piston may freely translate to a second, intermediate position 24. The piston 14 may remain at this second position 24 until the net force 54 exceeds any pre-loaded force of the biasing feature 40. Once the pre-loaded force is overcome, the biasing feature 40 may begin to compress at a constant rate 68 (i.e., the spring rate). Following the compression of the biasing feature 40, the piston 14 may encounter a stop, such as through contact with a portion of the housing, where subsequently applied force will not result in further movement. Thus, an increasing force in the third range 64 will result in the piston 14 being stable at a third position 28.

FIG. 3 illustrates the behavior of the actuator based on the controlled input pressures at apertures 36, 38. As illustrated, the first row contains the three piston positions (20, 24, and 28), and the column on the left contains the two controlling aperture references (36 and 38). The body of the table then identifies the pressure state required at each aperture that may achieve the actuator positions (i.e., a positive pressure state 70 or an exhausted state 72). As shown, to move the piston 14 to the first position 20, aperture 36 may be exhausted 72, while aperture 38 is pressurized 70. To move the piston 14 to the second position 24, both apertures 36, 38 may be pressurized, and to move the piston to the third position 28, aperture 36 may be pressurized 70, while aperture 38 is exhausted 72.

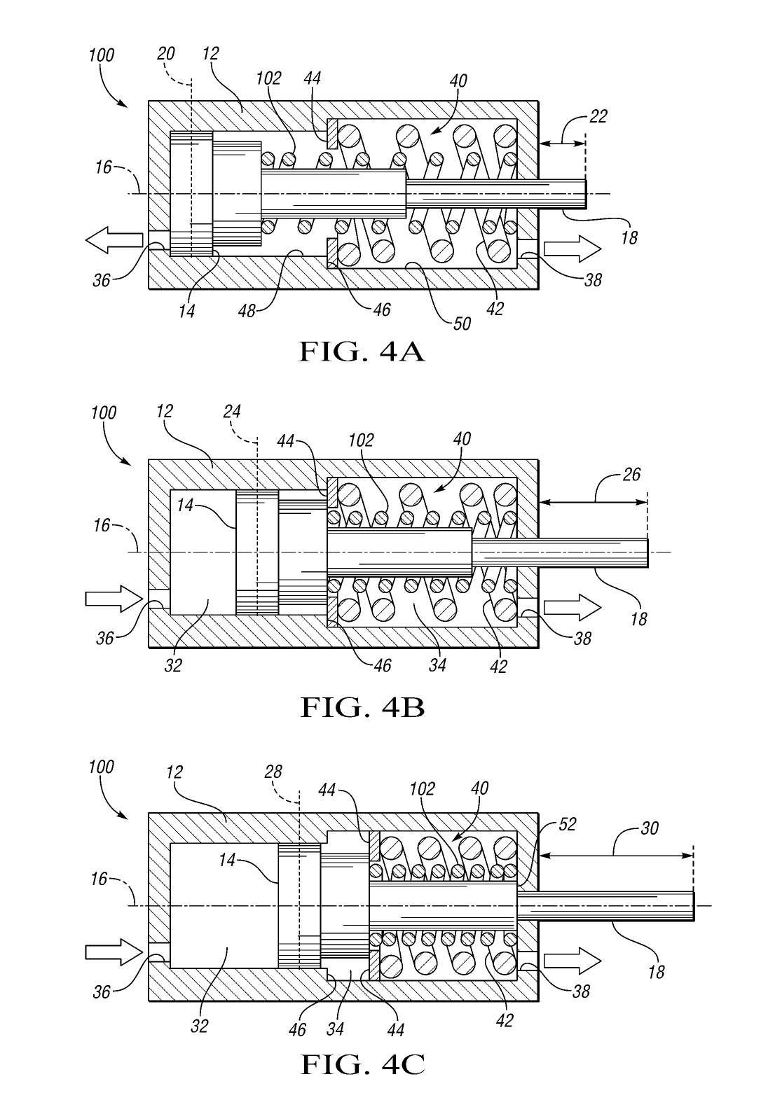

FIGS. 4A-4C illustrate another embodiment of a hydraulic actuator assembly 100 that may only require controlled pressure at one aperture (i.e., aperture 36). As shown, the hydraulic actuator assembly 100 may be similar in function and design as the hydraulic actuator assembly 10 illustrated in FIGS. 1A-1C. The assembly 100, however, may further include a second biasing feature 102 that is configured to engage the piston 14 over the entire range of motion. Biasing the piston over the entire working range (in addition to the second portion of the range) may allow the piston position to be controlled solely through a varied positive pressure at aperture 36, while the full-range biasing feature 102 may return the piston 14 to the initial extreme position 20 when pressure is removed from aperture 36.

In an embodiment, the full-range biasing feature 102 may include a spring 104 that is configured to apply a force to the piston either directly, or through one or more intermediate components (e.g., a contact ring, or a portion of the actuator rod 18). In an embodiment, the spring 104 may be pre-loaded such that, in the absence of any hydraulic pressure, the piston may be forced against the housing 12 or against another extreme position with some minimal force.

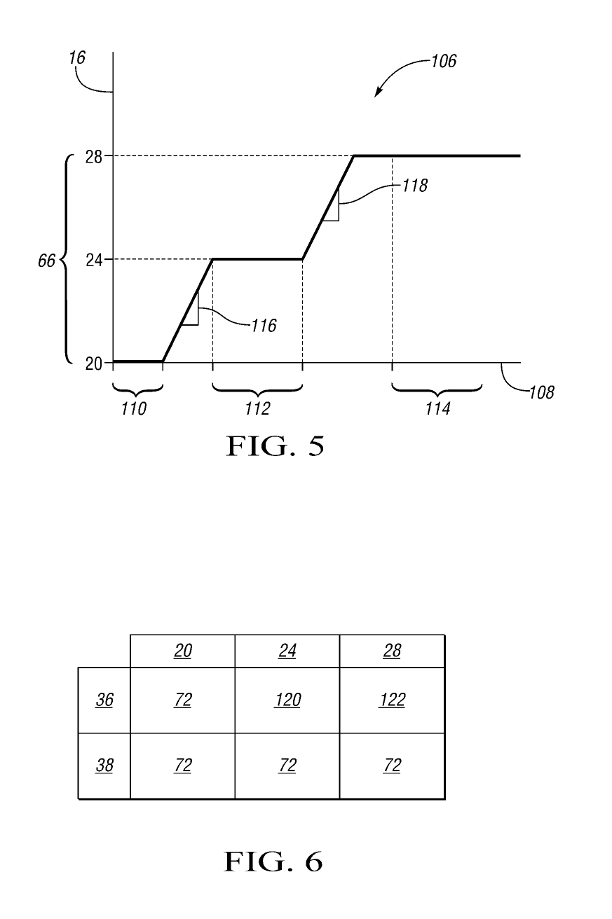

FIG. 5 is an exemplary graph 106 of a piston position along a working axis 16 of a hydraulic actuator assembly 100 as a function of a hydraulic pressure 108 at, for example, an aperture 36. The graph 106 in FIG. 5 may be representative of the operation of a hydraulic actuator assembly 100 such as the one shown in FIGS. 4A-4C. As illustrated, the piston position may be stable over three distinct input pressure ranges 110, 112, and 114, with each range resulting in a different position along the working-axis 16 (i.e., positions 20, 24, and 28, respectively).

In the first force range 110, the piston 14 may experience a hydraulic pressure that is not substantial enough to overcome any pre-loaded force applied by the full-range biasing feature 102. Therefore, the full-range biasing feature 102 may urge the piston 14 to remain at the first position 20 (i.e., at the extreme end of a working range 66) until the pre-loaded force is overcome. Once the force exerted by the hydraulic pressure 108 exceeds this pre-loaded biasing force, the piston 14 may begin moving toward a second, intermediate position 24, at a rate 116 directly proportional to the increasing pressure (i.e., a first spring rate).

At the second, intermediate position 24, the piston may contact the primary biasing feature 40. The piston 14 may then remain at this second position 24 until the force exerted by the hydraulic pressure 108 exceeds any pre-loaded force of the primary (partial-range) biasing feature 40. Once the pre-loaded force is overcome, the biasing feature 40 may begin to compress at a constant rate 118 (i.e., a spring rate). Following the compression of the primary biasing feature 40, the piston 14 may encounter a stop, such as through contact with a portion of the housing 12, where subsequently applied pressure will not result in further movement. Thus, an increasing pressure in the third range 114 will result in the piston 14 being stable at a third position 28.

Similar to FIG. 3, the state table in FIG. 6 illustrates the behavior of the actuator 100 (shown in FIGS. 4A-4C) based on the controlled input pressures at apertures 36, 38. As illustrated, the first row contains the three piston positions (20, 24, and 28), and the column on the left contains the two controlling aperture references (36 and 38). The body of the table then identifies the pressure state required at each aperture that may achieve the actuator positions (i.e., a first positive pressure state 120, a second positive pressure state 122, or an exhausted state 72). As shown, to move the piston 14 to the first position 20, both apertures 36, 38 may be exhausted 72. To move the piston 14 to the second position 24, the second aperture 38 may remain exhausted 72, while the first 26 is pressurized to a first positive pressure 120. To then move the piston 14 to the third position 28, the second aperture 38 may remain exhausted 72, while the first 26 is pressurized to a second positive pressure 122 that is greater than the first pressure 120.

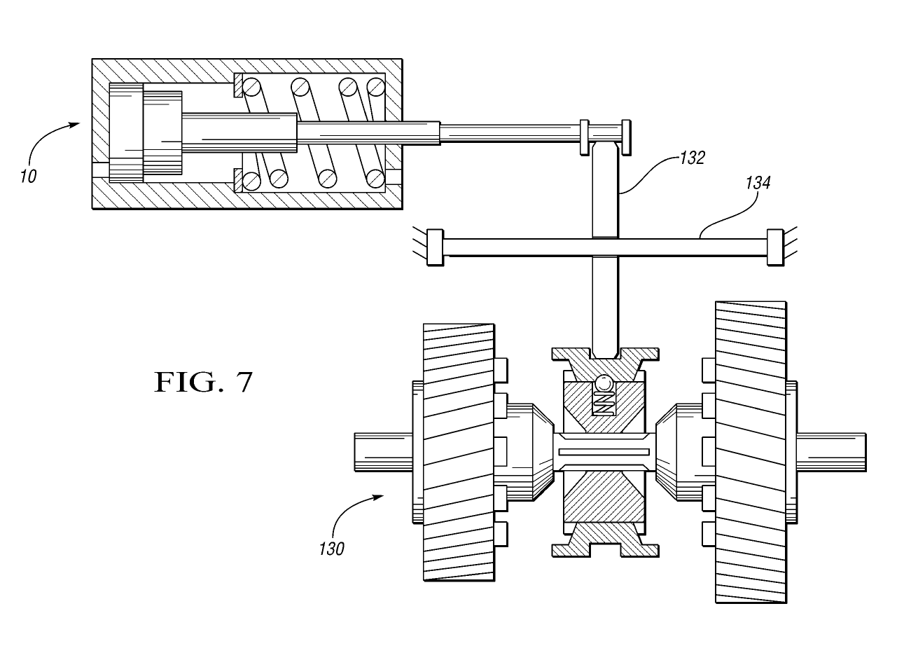

As diagrammatically illustrated in FIG. 7, an embodiment of a hydraulic actuator assembly (e.g., assembly 10) may be used to engage a transmission synchronizer gear assembly 130 within a dual-clutch automotive powertrain transmission. As illustrated, the actuator rod 18 of the assembly 10 may interface with a synchronizer control fork 132 that may be configured to translate along a guide rail 134. The synchronizer gear assembly 130 may then similarly translate in a linear fashion with the motion of the control fork 132, and may engage with other gears of the transmission assembly.

While the best modes for carrying out the invention have been described in detail, those familiar with the art to which this invention relates will recognize various alternative designs and embodiments for practicing the invention within the scope of the appended claims. All directional references (e.g., upper, lower, upward, downward, left, right, leftward, rightward, above, below, vertical, and horizontal) are only used for identification purposes to aid the reader's understanding of the present invention, and do not create limitations, particularly as to the position, orientation, or use of the invention. It is intended that all matter contained in the above description or shown in the accompanying drawings shall be interpreted as illustrative only and not as limiting.

1. A three-position actuator assembly comprising:
a housing;
a piston disposed within a portion of the housing and having a movable range along a working-axis, the piston separating a first volume and a second volume within the housing; and
a biasing feature disposed within the second volume; the piston configured to engage the biasing feature within a first portion of the movable range, and configured to not engage the biasing feature within a second portion of the movable range.

2. The actuator assembly of claim 1, wherein the biasing feature is a first biasing feature, the assembly further comprising a second biasing feature configured to engage the piston throughout the movable range.

3. The actuator assembly of claim 1, wherein the biasing feature includes a spring.

4. The actuator assembly of claim 3, wherein the biasing feature further includes a contact ring.

5. The actuator assembly of claim 1, wherein the housing includes a land, and the biasing feature is configured to apply a force to the land when the piston is in the second portion of the movable range.

6. The actuator assembly of claim 5, wherein the housing includes two fluidly connected cavities having different cross-sectional profiles, and wherein the land comprises a shoulder between the two cavities.

7. The actuator assembly of claim 1, wherein a pressure difference between the first and second volumes imparts a net hydraulic force to the piston, and a net hydraulic force in a first range causes the piston to assume a first position along the working-axis, a net hydraulic force in a second range causes the piston to assume a second position along the working-axis, and a net hydraulic force in a third range causes the piston to assume a third position along the working-axis.

8. The actuator assembly of claim 7, wherein the piston is positionally stable within each of the first, second and third net hydraulic force ranges.

9. The actuator assembly of claim 7, wherein one of the positions along the working-axis is within the second portion of the movable range.

10. The actuator assembly of claim 7, wherein the housing includes a plurality of apertures, and the pressure gradient is altered by controllably allowing fluid to pass through an aperture.

11. A three-position actuator for engaging a transmission synchronizer, the actuator comprising:
a housing;
a piston disposed within a portion of the housing and having a movable range along a working-axis, the piston separating a first volume and a second volume within the housing;
a biasing feature disposed within the second volume; the piston configured to engage the biasing feature within a first portion of the movable range, and configured to not engage the biasing feature within a second portion of the movable range; and
an actuator rod coupled with the piston and mechanically connected with a synchronizer gear assembly.

12. The actuator of claim 11, wherein the biasing feature is a first biasing feature, the assembly further comprising a second biasing feature configured to engage the piston over the entire range.

13. The actuator of claim 11, wherein the biasing feature includes a spring.

14. The actuator of claim 13, wherein the biasing feature further includes a contact ring, and wherein the spring is configured to apply a force between the contact ring and the housing.

15. The actuator of claim 11, wherein the housing includes a land, and the biasing feature is configured to apply a force to the land when the piston is in the second portion of the movable range.

16. The actuator of claim 15, wherein the housing includes two fluidly connected cavities having different cross-sectional profiles, and wherein the land comprises a shoulder between the two cavities.

17. The actuator of claim 11, wherein a pressure difference between the first and second volumes imparts a net hydraulic force to the piston, and a net hydraulic force in a first range causes the piston to assume a first position along the working-axis, a net hydraulic force in a second range causes the piston to assume a second position along the working-axis, and a net hydraulic force in a third range causes the piston to assume a third position along the working-axis.

18. The actuator of claim 17, wherein one of the positions along the working-axis is within the second portion of the movable range.

19. The actuator of claim 17, wherein the housing includes a plurality of apertures, and the pressure gradient is altered by controllably allowing fluid to pass through an aperture.

20. The actuator of claim 17, wherein the piston is positionally stable within each of the first, second and third net hydraulic force ranges.
